(19) United States
(12) Patent Application Publication
(10) Pub. No.: US 2012/0152682 A1
(43) Pub. Date: Jun. 21, 2012

(54) ONE-WAY RATCHET UNIT FOR A BICYCLE WHEEL

(75) Inventors: Tseng-Ping TIEN, Taichung City (TW); Hao-Jan Wang, Taichung City (TW)

(73) Assignee: FOSS WORLDWIDE INC., Taichung City (TW)

(21) Appl. No.: 13/292,681

(22) Filed: Nov. 9, 2011

(30) Foreign Application Priority Data
Dec. 20, 2010 (TW) 099144677

(51) Int. Cl. F16D 41/069

(52) U.S. Cl. 192/43.1; 192/45.1

(57) ABSTRACT

A one-way ratchet unit for a bicycle wheel has first and second meshing parts and an elastic member. The meshing parts are respectively configured on the bicycle wheel and the sprocket driving seat, their first and second one-way ratchets both comprise ratchet tips, ratchet roots and oblique guiding facets. The ratchet tips of the first or second one-way ratchet are configured with at least one wedge on partial positions, and the positions on the ratchet tips of the first or second one-way ratchet not forming the wedges form convex resisting edges. The ratchet roots of the second or first one-way ratchet are configured with wedge avoiding parts on partial positions, so that when the first and second one-way ratchets mesh each other and the resisting edges of the ratchet tips resist against the ratchet roots, said ratchet tips can be aligned and go into the wedge avoiding parts.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a bicycle wheel, and more particularly to a one-way ratchet assembly for use in the bicycle wheel structure.

2. Description of Related Art Including Information Disclosed Under 37 CFR 1.97 and 37 CFR 1.98

As the rear wheel of the bicycle is driven by the chain, to avoid contra-rotation of the wheel upon back-pedaling, the wheel must have a one-way ratchet assembly. With this one-way ratchet assembly, upon positive rotation, the chain will drive the wheel for rotation in one direction. Upon reversing rotation, the chain will only rotate in an idle mode and will not drive the wheel.

The traditional structure of a one-way ratchet assembly for the bicycle wheel is depicted in FIG. 1, wherein, the inner ratchets 11 and outer ratchets 21 are in a radial meshing state (from the axle center of the wheel). The inner ratchets 11 are configured continuously on the inner wall on one side of the wheel 10. A plurality of outer ratchets 21 are configured around the periphery of one side of the sprocket driving seat 20. Each outer ratchet 21 has an elastic tendency to move outward due to the configuration of the spring strip 22. In action, when the sprocket driving seat 20 is driven in one direction by the chain, the outer ratchets 21 will push the inner ratchets 11 to rotate simultaneously and to drive the wheel 10. When the sprocket driving seat 20 is driven oppositely, the outer ratchets 21 will move inward along the slopes of the inner ratchets 11 to effect an idle mode in which the wheel 10 is not driven by the ratchets. However, such a prior-art one-way ratchet unlit assembly still has the following problems in actual application.

It can be known from the above description that, when the sprocket driving seat 20 drives the wheel 10, the strength is closely related to the structural design of the inner and outer ratchets 11, 21. When the bicycle is frequently used in intensive conditions, such as climbing or speeding, the tensile strength between the inner and outer ratchets 11 and 21 is critical. In such conditions, the bicycle rider will inevitably pedal with great force to reach the best speed, but as a result, when driving the wheel 10, the sprocket driving seat 20 will receive such great force and suffer wear and tear. Currently, most bicycles are damaged due to deformation or breakage of the outer ratchets 21 configured on the sprocket driving seat 20. This can cause seizure of the entire one-way ratchet assembly and as a result, non-working of the bicycle. One could dramatically increase the width of the inner and outer ratchets 11, 21 to increase their tensile strength. However, in this way, although the tensile strength is increased, the enlarged contacting surface between the inner and outer ratchets 11, 21 will also cause too much frictional force when the inner and outer ratchets 11, 21 are in an idle driving mode. This can consequently lead to unsmooth movement or even collapse of the teeth.

FIG. 2 depicts another traditional structure of the one-way ratchet assembly for the bicycle wheel. This example differs from the structure depicted in FIG. 1 mainly in that the inner ratchets 31 and outer ratchets 32 are in a axial meshing state (from the axle center of the wheel). Another difference is that; both the inner ratchets 31 and outer ratchets 32 are made up of continuous teeth in a ring-shaped array. The idle driving mode is effected by a spring 33 pushing a sliding seat 34 configured with the inner ratchets 31. Nonetheless, such a traditional one-way ratchet unit has similar problems and shortcomings like the previous structure. Thus, to overcome the aforementioned problems of the prior art, it would be an improvement to provide a structure that can significantly improve the efficacy.

### BRIEF SUMMARY OF THE INVENTION

The present invention has the ratchet tips of the first or second one-way ratchet configured with wedges in partial positions. The opposite ratchet roots of the ratchet are correspondingly configured with wedge avoiding parts. When the first and second meshing parts mesh with each other to enter a driving mode, the contacting happens between the wider resisting edge and the ratchet roots and therefore the resisting force is less. On the other hand, when the first and second meshing parts are in an idling mode, the friction only happens between the narrower wedge and the oppositef one-way ratchet, and therefore the frictional resistance and wearing minimal. The present invention can substantially increase the driving intensity of the ratchets of the one-way ratchet assembly, and can minimize the frictional resistance in the idling mode.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 is a perspective view of an embodiment of the prior-art structure.

FIG. 2 is a perspective view of another embodiment of the prior-art structure.

FIG. 3 is an exploded perspective view of a preferred embodiment of the structure of the present invention.

FIG. 4 is an enlarged view of Part B in FIG. 3.

FIG. 5 is an enlarged view of Part C in FIG. 3.

FIG. 6 is a schematic view of the ratchets in a driven mode.

FIG. 7 is a schematic view of the ratchets in a non-driven mode.

FIG. 8 is an enlarged perspective view of part of the ratchets in a driven mode.

FIG. 9 is enlarged perspective view of part of the ratchets in a non-driven mode.

FIG. 10 is a perspective view of another embodiment of the wedge style of the present invention.

FIG. 11 is a perspective view of a further embodiment of the wedge style of the present invention.

FIG. 12 is a perspective view of another embodiment of the structure of the first and second meshing parts of the present invention.

FIG. 13 is an enlarged view of the first and second meshing parts in FIG. 12.

FIG. 14 is a schematic drawing of the wedges of the present invention in an assembled structural state.

FIG. 15 is a schematic drawing of the wedges of the present invention in a plastic combined structural state.

FIG. 16 is a schematic drawing of the one-way ratchet part of the present invention in an assembled structural state.

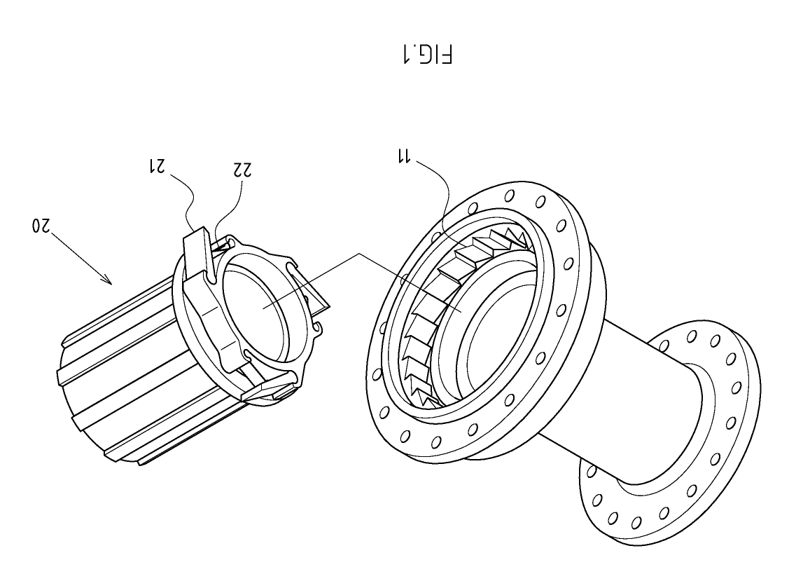

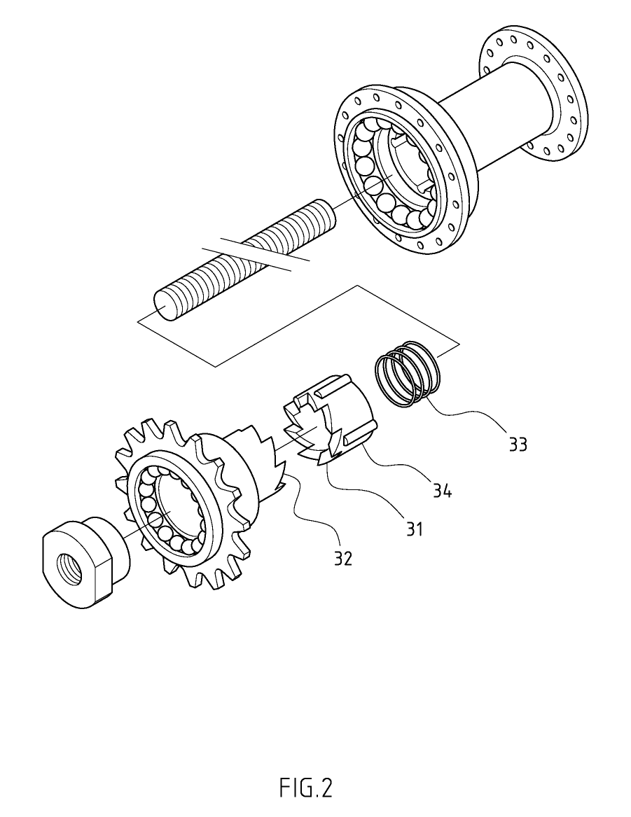

### DETAILED DESCRIPTION OF THE INVENTION

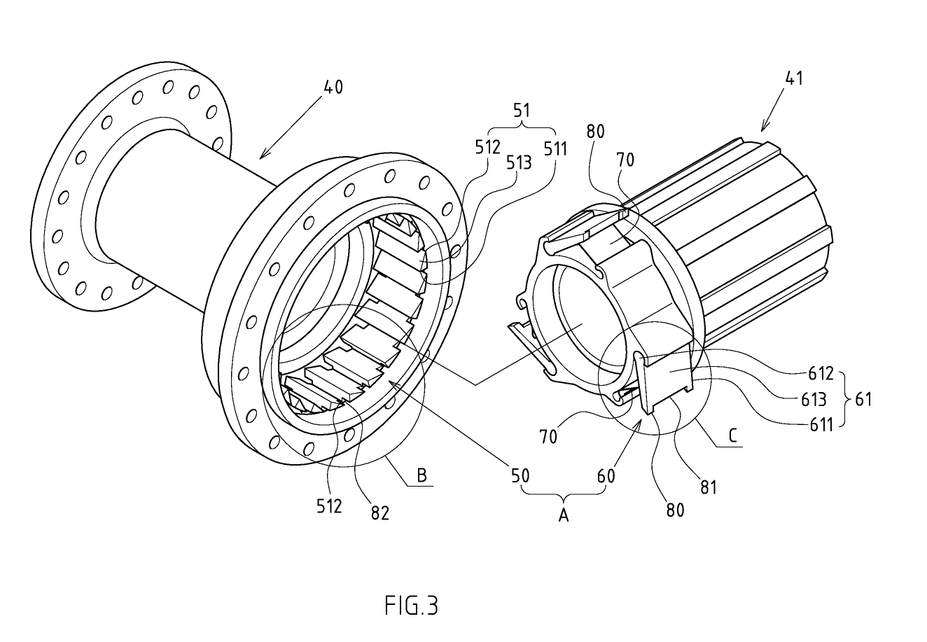

FIGS. 3, 4, and 5 depict a preferred embodiment of a one-way ratchet assembly for the bicycle wheel. However, such an embodiment is illustrative only, and is not intended to be limiting of the scope of the patent application. The one-way ratchet assembly A is used for a one-way rotation between the bicycle wheel 40 and the sprocket driving seat 41 on one side of the bicycle wheel 40.

The one-way ratchet assembly A comprises a first meshing part 50 configured on one side of the bicycle wheel 40. The first meshing part comprises a plurality of first ratchets 51 distributed in a ring-shaped array. The first ratchets 51 comprises ratchet tips 511, ratchet roots 512 and oblique guiding facets 513.

A second meshing part 60 is positioned on one side of the sprocket driving seat 41. The second meshing part 60 comprises a plurality of second ratchets 61 distributed in a ring-shaped array. The second ratchet 61 comprises ratchet tips 611, ratchet roots 612 and oblique guiding facets 613. The teeth of second ratchet 61 can mesh with the first ratchet 51 of the first meshing part 50, and the two ratchets can only be meshed in one direction, while in the other direction, they will push apart from each other to effect an idling mode.

At least one elastic member 70 is provided by which when the first meshing part 50 and second meshing part 60 are in an idle driving mode, they can push apart from each other.

At least one wedge 80 projects from a partial position of the ratchet tips 511, 611 of either the first ratchet 51 or the second ratchet 61. The projecting direction of the wedge 80 is along the oblique extending path of the oblique guiding facets 513 or 613. Moreover, the positions on the ratchet tips 511 or 611 of the first ratchet 51 or second one-way ratchet 61 without the wedges 80 form a relatively recessed resisting edge 81.

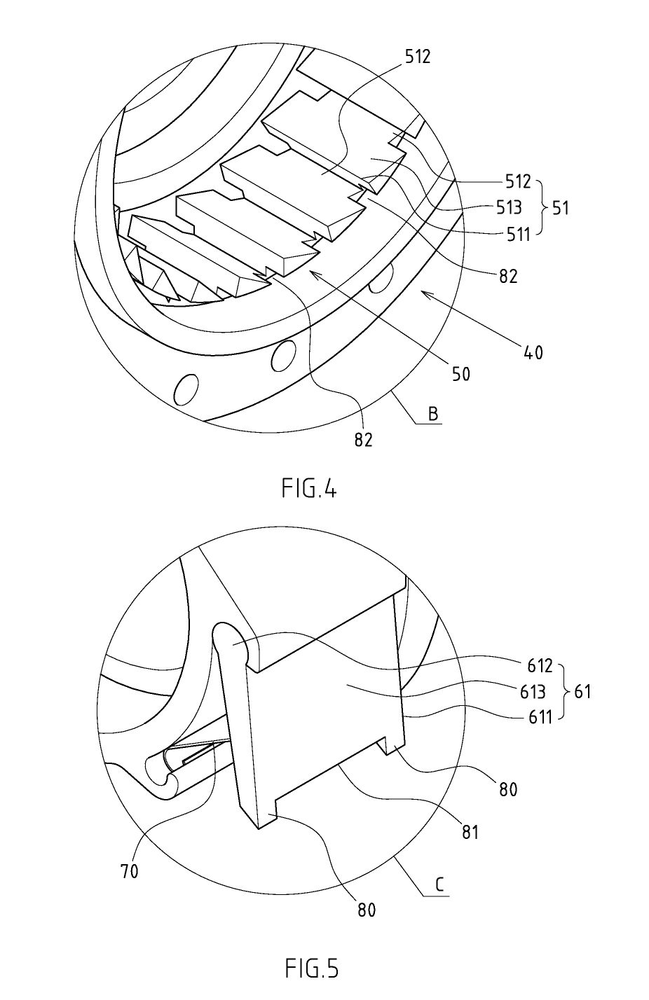

At least one wedge avoiding part 82 is configured in an indented manner on partial positions of the ratchet roots 612 or 512 of either the second ratchet 61 or first ratchet 51. When the first and second ratchets 51, 61 mesh with each other, and the ratchet tips 511 or 611 and the resisting edge 81 are resisted against the ratchet roots 612 or 512, the wedge 80 will be aligned and go into the wedge avoiding part 82. The style of the wedge avoiding part 82 of the present embodiment is depicted in FIG. 4. It is made of recessed slots in a ring-shaped arrangement along each of the ratchet roots 512 (or 612).

As shown in FIGS. 3, 4 and 5, the first meshing part 50 can be configured in the shape of a ring on one side of the bicycle wheel 40. In the first ratchet 51, the ratchet tips 511 form a ring-shaped array of continuous teeth projecting in the direction of the axis of the bicycle wheel 40. The second meshing part 60 is in a ring shape and configured on one side of the sprocket driving seat 41. The second one-way ratchet 61 is made up of spaced and movable teeth. The ratchet roots 612 have rotating fulcrums so that the ratchet tips 611 can be revolved. When the ratchet tips 611 swing outward, the resisting edges 81 can resist against the ratchet roots 512 of the first one-way ratchet 51. The elastic members 70 can be made of spring strips (or springs), and are configured on the second meshing part 60 at positions corresponding to each second ratchet 61, so that each second ratchet 61 has a recovering tendency to swing outward. When each second ratchet 61 swings inward under pressure, the elastic member 70 will accumulate elastic force.

Alternatively, the revolving second ratchets 61 can also be configured on the first meshing part 50. The first one-way ratchet 51, in the form of continuous teeth, can be accordingly configured on the second meshing part 60.

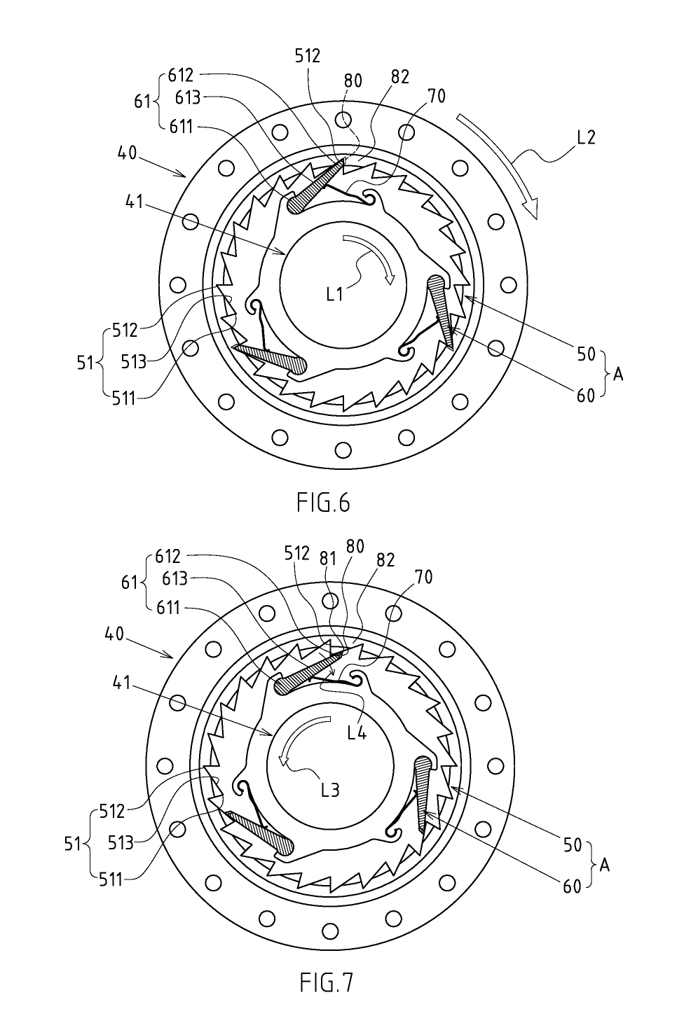

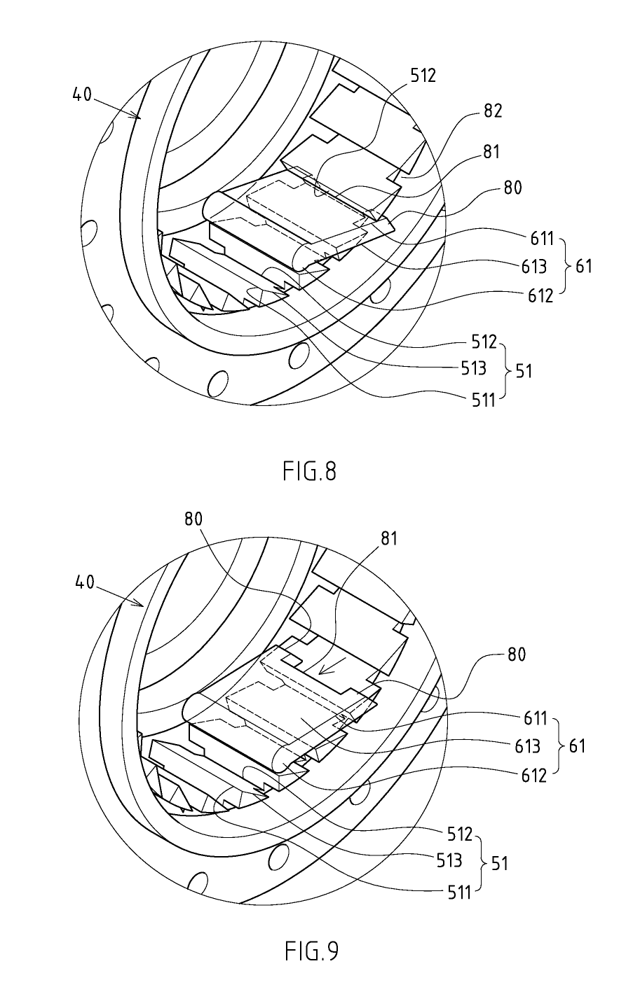

Referring to FIGS. 6 and 8, when the sprocket driving seat 41 is driven by the bicycle chain (omitted in the figure) and rotates in one direction (as indicated by Arrow L1). The second one-way ratchet 61 of the second meshing part 60 will simultaneously rotate in the same direction. At this time, as the ratchet tips 611 of the second ratchet 61 are resisted by the elastic member 70 and swing to an outward angle, and the ratchet tips 611 are pointing to the direction of the ratchet roots 512 of the first ratchets 51 of the first meshing part 50, they will push the bicycle wheel 40 so as to rotate in the same direction (as indicated by Arrow L2). Moreover, the wedges 80 are now aligned to and enter into the wedge avoiding parts 82. Therefore, the resisting force is not endured by the wedges 80, but by the resisting edges 81 on the ratchet tips 611 of the second ratchet 61 and the ratchet roots 512 of the first ratchet 51.

On the other hand, referring to FIGS. 7 and 9, when the sprocket driving seat 41 rotates in the opposite direction (as indicated by Arrow L3), the second one-way ratchets 61 of the second meshing part 60 will simultaneously rotate in the opposite direction. At this time, as the second ratchet 61 is having its oblique guiding facets 613 pointing to the oblique guiding facets 513 on the firs ratchets 51 of the first meshing part 50, the second ratchets 61 will swing inward under the guidance of the oblique surface (as indicated by Arrow L4), and will not drive the bicycle wheel 40 (i.e., now it is in an idling mode). Further, during the non-driving rotation of the ratchet tips 611 of the second ratchets 61 the contact and friction only happens between the narrow wedges 80 and the oblique guiding facets 513 configured on the first ratchet 51, and the resisting edges 81 configured on the ratchet tips 611 of the second one-way ratchets 61 are not contacting the oblique guiding facets 513 of the first ratchet 51.

The present invention allows friction only on a small area between the narrow wedges 80 and the opposite ratchets 51 and 61 when the first and second meshing parts 50, 60 are rotating in a non-driving state. This ensures minimum frictional resistance and wearing in the idling mode of the one-way ratchet assembly. With this structure, the area of the resisting edges 81 can be relatively enlarged. For example, since the ratchet width of the prior-art one-way ratchet unit is 8 millimeters, it means the contacting width in both the driving state and the non-driving state is 8 millimeters. But in the present invention, the ratchet width is increased to 20 millimeters. As disclosed in FIG. 5, the wedge 80 can be configured with two teeth, with each teeth of the wedge 80 having a width of 2 millimeters. Hence, in the driving state, the ratchet contacting width of the present invention is 16 millimeters, which is twice that of 8 millimeters as in the prior art. Therefore, in the driving state, the force endured by the ratchets is considerably increased. On the other hand, in the non-driving state, the ratchet contacting width is only 4 millimeters, just only half of 8 millimeters as in the prior art. Hence, in the idling mode of the present invention, the ratchet frictional resistance and wearing can be dramatically reduced. The present invention can improve both the driving intensity and idling frictional resistance of the prior-art bicycle wheel one-way ratchet assembly.

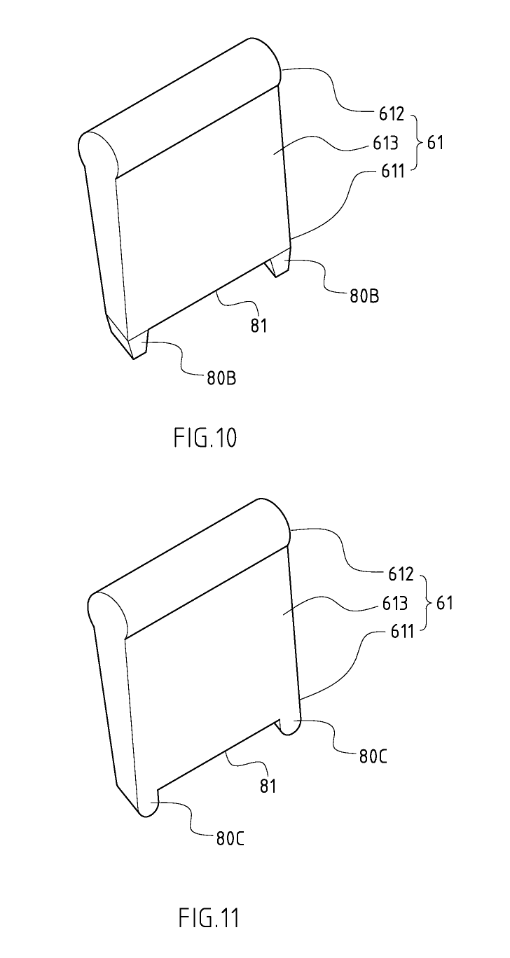

The wedges 80 can be provided in various shapes. For example, the wedges 80 shown in FIG. 5 are rectangular. The wedges 80B shown in FIG. 10 are trapezoidal. The wedges 80C shown in FIG. 11 are in the shape of a convex arc. Apart from the above, other shapes such as triangles, semicircles, etc. can also be implemented and adopted as the shape of the wedges.

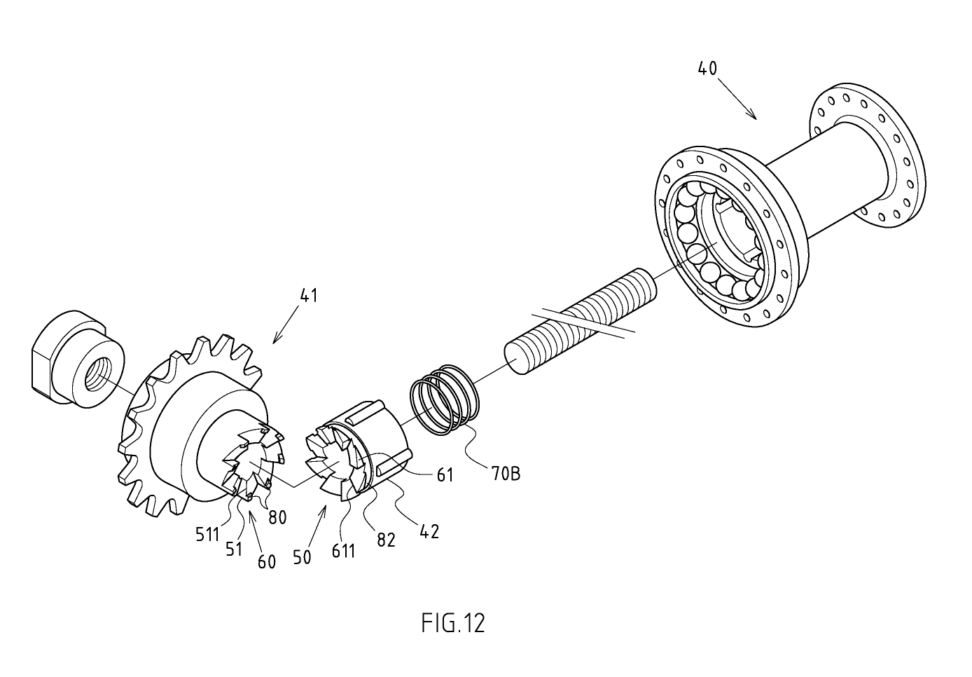

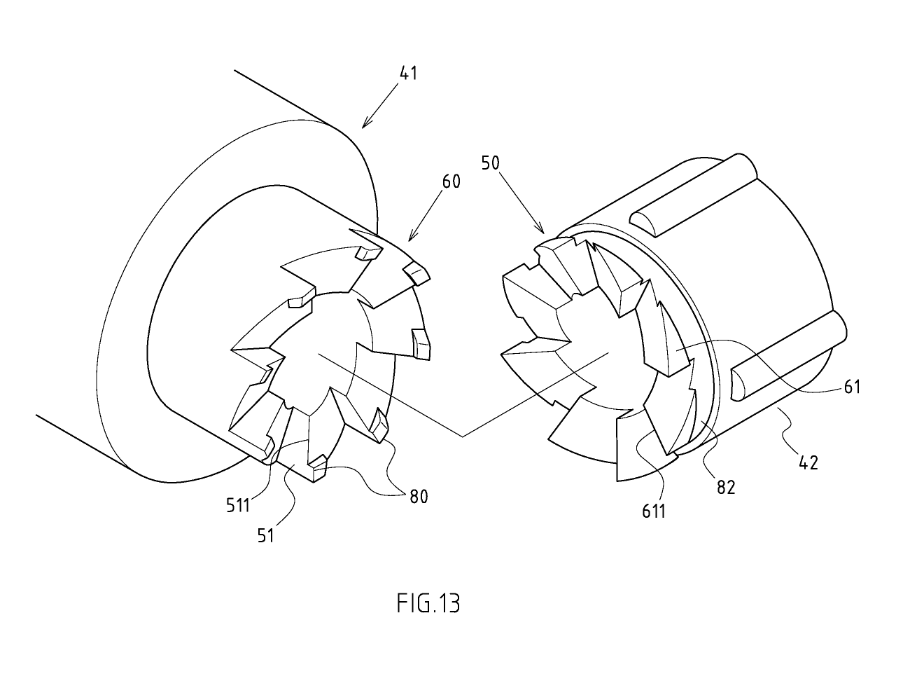

FIGS. 12 and 13 disclose another embodiment of the first and second meshing parts of the present invention. In this embodiment, one side of the bicycle wheel 40 contains a flexible block 42, and the first meshing part 50 is configured in a ring shape on the external end surface of the flexible block 42 in the axial direction. The ratchet tips of the first ratchets 51 are in the form of a ring-shaped array of continuous teeth pointing to the end of the bicycle wheel 40. The second meshing part 60 is in a ring shape and configured on one side of the sprocket driving seat 41 in the radial direction, and its second ratchets 61 are also in the form of a ring-shaped array of teeth corresponding to the first ratchets 51, so that the first and second one-way ratchets 51, 61 can mesh each other in the radial direction. The elastic member 70B is made of a spring configured on the inner end of the flexible block 42, so that the flexible block 42 can be pushed outward elastically and has a tendency to recovery. When the flexible block 42 withdraws under pressure, the elastic member 70B will accumulate recovering elasticity.

The wedges 80 can be configured at the two side positions on the ratchet tips 511 or 611 of either the first ratchet 51 or the second ratchet 61 (as detailed in FIG. 5). Alternatively, the wedge 80 can be singularly configured at any position between, or at either side position, of the two sides of the ratchet tips 511 or 611 of either the first one-way ratchets 51 or the second one-way ratchets 61.

The wedges 80 can be configured in multiple at any position between the two sides of the ratchet tips 511 or 611 of either the first ratchets 51 or the second ratchets 61.

Moreover, the wedges 80 and the ratchet tips 511 or 611 of the first ratchet 51 or the second ratchet 61 can be an integrally formed structure, or can be an assembled.

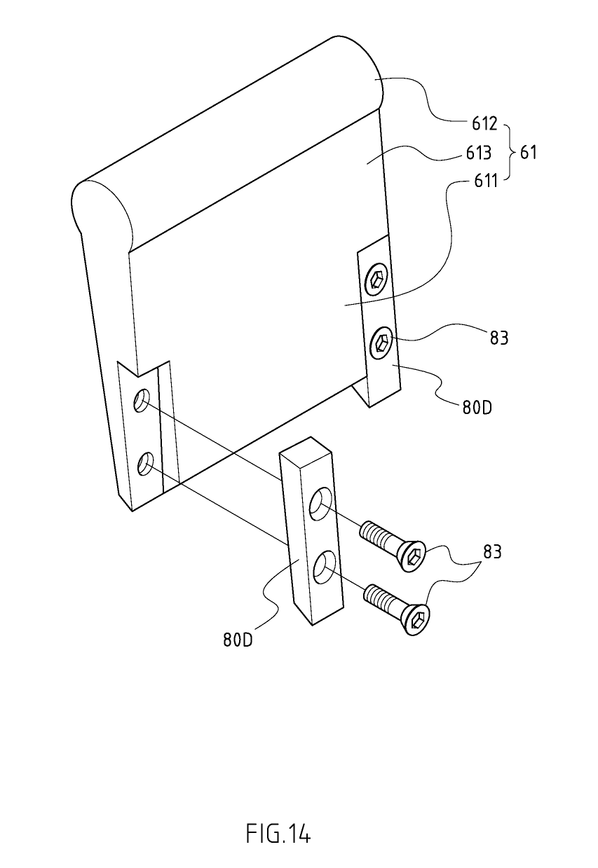

When the wedges 80 and the ratchet tips 611 (or 511) of the second ratchet 61 (or the first ratchet 51) is of an assembled and fixed structure, they can be fixed through bolts 83 (like the wedges 80D shown in FIG. 14), or by insertion.

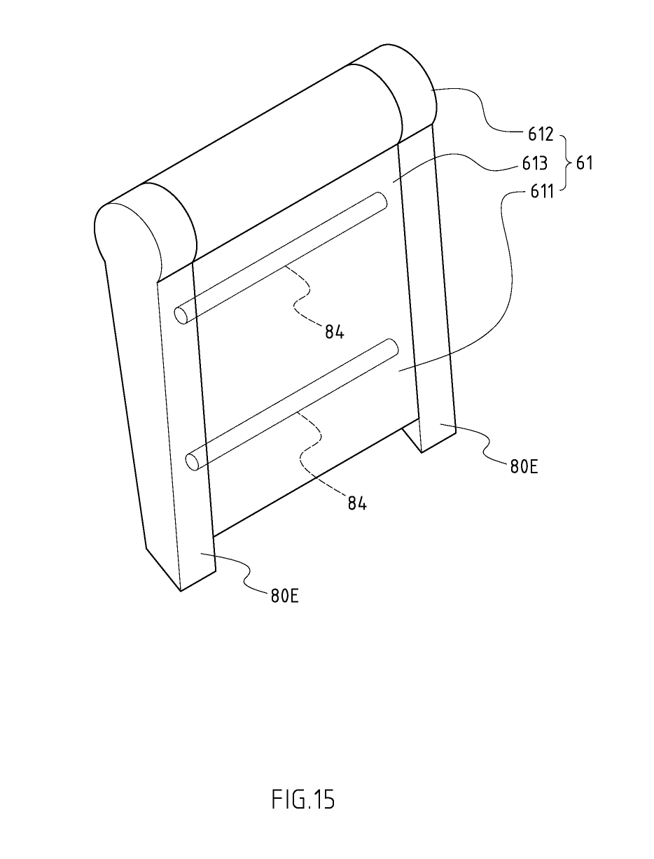

The above-mentioned integrally formed wedges 80 can be made of metal. Alternatively, like the wedges 80E disclosed in FIG. 15, they can be of plastic material and combine with the metal ratchet tips 611 (or 511) of the second ratchet 61 (or first ratchet 51). In such an embodiment, the metal second ratchet 61 (or first ratchet 51) is configured with plastics inserting holes 84 for the plastic wedges 80E to be partially inserted into the holes and can be fixed.

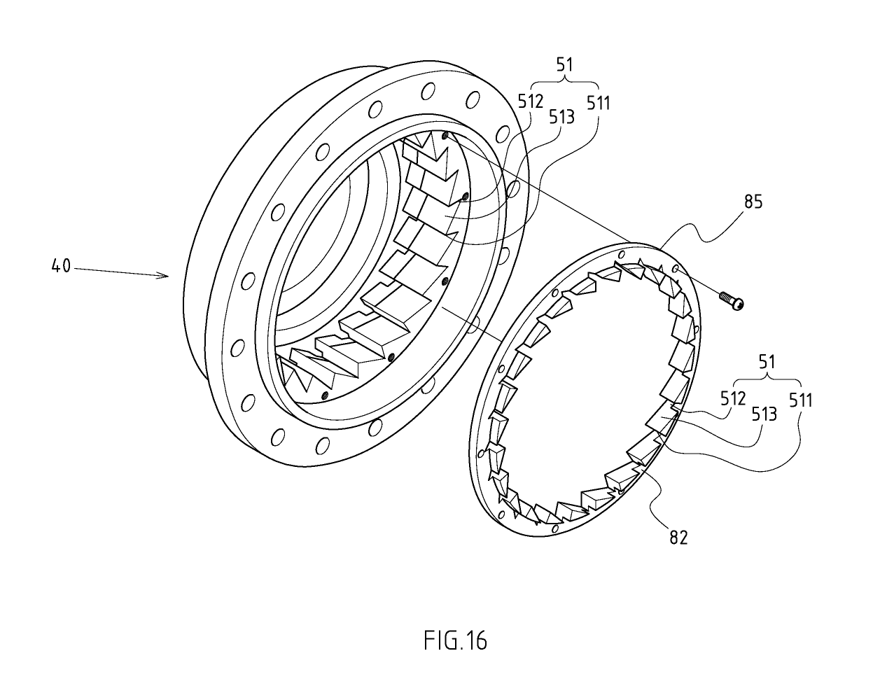

Referring to FIG. 16, the second ratchet 61 or first ratchet 51 are configured with the wedge avoiding part 82 preset on a ring 85 and then fixed through bolt locking Alternatively, the second ratchet 61 or first ratchet 51 configured with the wedge avoiding parts 82 can be made of plastic material and then fixed with other parts of the metal second ratchet 61 or first ratchet 51.

1. A one-way ratchet unit for the bicycle wheel, which is used for a one-way driving state between the bicycle wheel and the sprocket driving seat configured on one side of the bicycle wheel said one-way ratchet unit comprises:
a first meshing part, configured on one side of the bicycle wheel, and comprising a plurality of first one-way ratchet distributed in a ring-shaped array; said first one-way ratchet comprises ratchet tips, ratchet roots and oblique guiding facets;
a second meshing part, configured on one side of the sprocket driving seat, and comprising a plurality of second one-way ratchet distributed in a ring-shaped array; said second one-way ratchet comprises ratchet tips, ratchet roots and oblique guiding facets; wherein, the teeth of second one-way ratchet can mesh with the first one-way ratchet of the first meshing part, and the two ratchets can only be meshed in one direction, while in the other direction, they will push apart from each other to effect an idling mode;
at least one wedge, projecting from a partial position of the ratchet tips of either said first one-way ratchet or second one-way ratchet; and the projecting direction of said wedge is along the oblique extending path of the oblique guiding facets. Moreover, the positions on the ratchet tips of the first one-way ratchet or second one-way ratchet without the wedges form a relatively recessed resisting edge;
at least one wedge avoiding part, configured in an indented manner on partial positions of the ratchet roots of either the second one-way ratchet or first one-way ratchet, so that when the first and second one-way ratchets mesh each other, and the ratchet tips and the resisting edge are resisted against the ratchet roots, said wedge will be aligned and go into the wedge avoiding part.

2. The structure defined in claim 1, wherein the first meshing part is configured in the shape of a ring on one side of the bicycle wheel in the radial direction; in the first one-way ratchet, the ratchet tips form a ring-shaped array of continuous teeth projecting to the direction of the axis of the bicycle wheel; the second meshing part is in a ring shape and configured on one side of the sprocket driving seat in the radial direction, and its second one-way ratchet is made up of spaced and movable teeth; the ratchet roots have rotating fulcrums so that the ratchet tips can be revolved; when the ratchet tips swing outward, the resisting edges can resist against the ratchet roots of the first one-way ratchet; said elastic members is made of spring strips or springs, and are configured on the second meshing part at positions corresponding to each second one-way ratchet, so that each second one-way ratchet has a recovering tendency to swing outward; and when each second one-way ratchet swing inward under pressure, the elastic member made of the spring strip or spring will accumulate elastic force.

3. The structure defined in claim 2, wherein the revolving second one-way ratchets can alternatively configured on the first meshing part, and the first one-way ratchet in the form of continuous teeth can be accordingly configured on the second meshing part.

4. The structure defined in claim 1, wherein one side of the bicycle wheel contains a flexible block, and the first meshing part is configured in a ring shape on the external end surface of the flexible block in the axial direction, and the ratchet tips of the first one-way ratchets are in the form of a ring-shaped array of continuous teeth pointing to the end of the bicycle wheel; the second meshing part is in a ring shape and configured on one side of the sprocket driving seat in the radial direction, and its second one-way ratchets are also in the form of a ring-shaped array of teeth corresponding to the first one-way ratchets, so that the first and second one-way ratchets can mesh each other in the radial direction; said elastic member is made of a spring, configured in a limited state on the inner end of the flexible block, so that the flexible block can be pushed outward elastically and have a tendency of recovery, and when the flexible block withdraws under pressure, the elastic member made of spring will accumulate recovering elasticity.

5. The structure defined in claim 1, wherein said wedge is configured at the two side positions on the ratchet tips of either the first one-way ratchet or the second one-way ratchet.

6. The structure defined in claim 1, wherein said wedge is singularly configured at any position between, or at either side position of the two sides of the ratchet tips of either the first one-way ratchets or the second one-way ratchets.

7. The structure defined in claim 1, wherein said wedge is configured in multiple at any positions between the two sides of the ratchet tips of either the first one-way ratchets or the second one-way ratchets.

8. The structure defined in claim 1, wherein said wedge is in the shape of any of the following: rectangle, trapezium, triangle, semicircle, or convex arc.

9. The structure defined in claim 1, wherein said wedge avoiding part is a recessing space formed through a ring-shaped groove and each of the ratchet roots.

10. The structure defined in claim 1, wherein said wedge and the ratchet tips of the first one-way ratchet or the second one-way ratchet are an integrally formed structure, or an assembled and fixed structure.

11. The structure defined in claim 10, wherein, said wedge and the ratchet tips of the first or second one-way ratchet is of an assembled structure, fixed through bolts or by insertion.

12. The structure defined in claim 1, wherein the second one-way ratchet or first one-way ratchet configured with the wedge avoiding part is preset on a ring and then fixed through bolt locking; or, the second one-way ratchet or first one-way ratchet configured with said wedge avoiding parts is made of plastic material and then fixed with other parts of the metal second one-way ratchet or first one-way ratchet.
